(19) United States
(12) Patent Application Publication
(10) Pub. No.: US 2011/0291030 A1
(43) Pub. Date: Dec. 1, 2011

(54) ACTIVE DEW POINT SENSING AND LOAD LOCK VENTING TO PREVENT CONDENSATION ON WORKPIECES

(75) Inventor: William D. Lee, Newburyport, MA (US)

(73) Assignee: Axcelis Technologies, Inc., Beverly, MA (US)

(21) Appl. No.: 13/116,580

(22) Filed: May 26, 2011

Related U.S. Application Data
(60) Provisional application No. 61/349,547, filed on May 28, 2010.

(51) Int. Cl. G21K 5/10; F27D 3/00

(52) U.S. Cl. 250/492.21; 414/804; 432/9

(57) ABSTRACT

A system, apparatus, and method is provided for preventing condensation on a workpiece in an end station of an ion implantation system. A workpiece is cooled in a first environment, and is transferred to a load lock chamber that is in selective fluid communication with the end station and a second environment, respectively. A workpiece temperature monitoring device is configured to measure a temperature of the workpiece in the load lock chamber. An external monitoring device measures a temperature and relative humidity in the second environment, and a controller is configured to determine a temperature of the workpiece at which condensation will not form on the workpiece when the workpiece is transferred from the load lock chamber to the second environment.

### REFERENCE TO RELATED APPLICATION

This application claims priority to and the benefit of U.S. Provisional Application Ser. No. 61/349,547 which was filed May 28, 2010, entitled “ACTIVE DEW POINT SENSING AND LOAD LOCK VENTING TO PREVENT CONDENSATION ON WORKPIECES”, the entirety of which is hereby incorporated by reference as if fully set forth herein.

### FIELD OF THE INVENTION

The present invention relates generally to ion implantation systems, and more specifically to a system, apparatus, and method for preventing condensation from forming on a workpiece in an ion implantation system.

### BACKGROUND OF THE INVENTION

Electrostatic clamps or chucks (ESCs) are often utilized in the semiconductor industry for clamping workpieces or substrates during plasma-based or vacuum-based semiconductor processes such as ion implantation, etching, chemical vapor deposition (CVD), etc. Clamping capabilities of the ESCs, as well as workpiece temperature control, have proven to be quite valuable in processing semiconductor substrates or wafers, such as silicon wafers. A typical ESC, for example, comprises a dielectric layer positioned over a conductive electrode, wherein the semiconductor wafer is placed on a surface of the ESC (e.g., the wafer is placed on a surface of the dielectric layer). During semiconductor processing (e.g., ion implantation), a clamping voltage is typically applied between the wafer and the electrode, wherein the wafer is clamped against the chuck surface by electrostatic forces.

For certain ion implantation processes, cooling the workpiece via a cooling of the ESC is desirable. At colder temperatures, however, condensation can form on the workpiece, or even freezing of atmospheric water on the surface of the workpiece can occur, when the workpiece is transferred from the cold ESC in the process environment (e.g., a vacuum environment) to an external environment (e.g., a higher pressure, temperature, and humidity environment). For example, after an implantation of ions into the workpiece, the workpiece is typically transferred into a load lock chamber, and the load lock chamber is subsequently is vented. When the load lock chamber is opened to remove the workpiece therefrom, the workpiece is typically exposed to ambient atmosphere (e.g., warm, “wet” air at atmospheric pressure), wherein condensation can occur on the workpiece. The condensation can deposit particles on the workpiece, and/or leave residues on the workpiece that can have adverse effects on front side particles (e.g., on active areas), and can lead to defects and production losses.

Therefore, a need exists in the art for a system, apparatus, and method for mitigating condensation on a workpiece when transferred from a cold environment to a warmer environment.

### SUMMARY OF THE INVENTION

The present invention overcomes the limitations of the prior art by providing a system, apparatus, and method for abating condensation on a workpiece in an ion implantation system. Accordingly, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present invention is directed generally toward a system, apparatus, and method for preventing condensation on a workpiece in an ion implantation system. The system comprises an source configured to form an ion beam, a beamline assembly configured to mass analyze the ion beam, an end station having a first environment associated therewith, wherein the end station comprises a chilled electrostatic chuck configured to clamp and cool the workpiece during an implantation of ions from the ion beam, and a load lock chamber in selective fluid communication with the end station and a second environment, respectively. The load lock chamber comprises a platen configured to accept the workpiece, wherein the platen comprises a workpiece temperature monitoring device configured to measure a temperature of the workpiece, and wherein the second environment generally has a higher dew point than the first environment. A secondary monitoring device is configured to measure a temperature and relative humidity, and thus measure and/or calculate a dew point, in the second environment, and a controller is configured to determine a temperature of the workpiece at which condensation will not form on the workpiece when the workpiece is transferred from the load lock chamber to the second environment. The determination is made based on data both from the workpiece temperature monitoring device and secondary temperature monitoring device, such as the dew point in the second environment.

Thus, to the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates schematic of a vacuum system comprising an ion implantation system in accordance with one example of the present invention.

FIG. 2 illustrates an exemplary load lock chamber in accordance with another aspect of the invention.

FIG. 3 is a graph illustrating temperature versus time for a workpiece warming with the gas according to another example.

FIG. 4 is flow diagram illustrating an exemplary method for preventing condensation on a workpiece according to another exemplary aspect of the invention.

### DETAILED DESCRIPTION OF THE INVENTION

The present invention is directed generally toward preventing condensation on a workpiece in an ion implantation system employing a chilled electrostatic chuck. Conventional warming of a workpiece without monitoring the temperature of the workpiece or the local dew point can lead to long vent times, and thus have a negative impact on workpiece throughput. This invention will describe a system, apparatus, and method for actively measuring the temperature of the workpiece and the local dew point outside a load lock chamber, and using this information to minimize the wait time, thus maximizing throughput.

Accordingly, the present invention will now be described with reference to the drawings, wherein like reference numerals may be used to refer to like elements throughout. It should be understood that the description of these aspects are merely illustrative and that they should not be interpreted in a limiting sense. In the following description, for purposes of explanation, numerous specific details are set forth in order to provide a thorough understanding of the present invention. It will be evident to one skilled in the art, however, that the present invention may be practiced without these specific details.

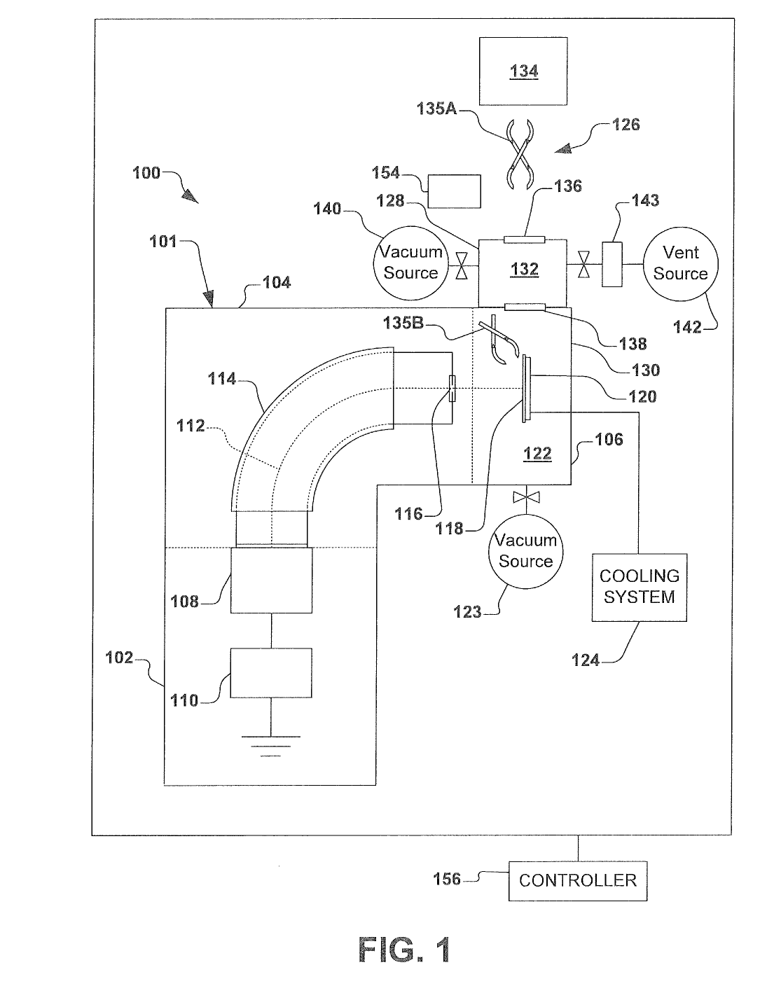

In accordance with one aspect of the present disclosure, FIG. 1 illustrates an exemplary vacuum system 100. The vacuum system 100 in the present example comprises an ion implantation system 101, however various other types of vacuum systems are also contemplated, such as plasma processing systems, or other semiconductor processing systems. The ion implantation system 101, for example, comprises a terminal 102, a beamline assembly 104, and an end station 106. Generally speaking, an ion source 108 in the terminal 102 is coupled to a power supply 110 to ionize a dopant gas and form an ion beam 112. The ion beam 112 is directed through a beam-steering apparatus 114, and out an aperture 116 towards the end station 106. In the end station 106, the ion beam 112 bombards a workpiece 118 (e.g., a semiconductor wafer, display panel, etc.), which is selectively clamped or mounted to an electrostatic chuck (ESC) 120 in a first environment 122 associated with the end station. The first environment 122, for example, comprises a vacuum produced by a vacuum system 123. Once embedded into the lattice of the workpiece 118, the implanted ions change the physical and/or chemical properties of the workpiece. Because of this, ion implantation is used in semiconductor device fabrication and in metal finishing, as well as various applications in materials science research.

Absent countermeasures, during an ion implantation utilizing the ion implantation system 101, energy can build up on the workpiece 118 in the form of heat, as the charged ions collide with the workpiece. This heat can warp or crack the workpiece 118, which may render the workpiece worthless (or significantly less valuable) in some implementations. The heat can further cause the dose of ions delivered to the workpiece 118 to differ from the dosage desired, which can alter functionality from what is desired. For example, if a dose of 1×10¹⁷ atoms/cm³ are desired to be implanted in an extremely thin region just below the outer surface of the workpiece 118, unexpected heating could cause the delivered ions to diffuse out from this extremely thin region such that the dosage actually achieved is less than 1×10¹⁷ atoms/cm³. In effect, the undesired heating can “smear” the implanted charge over a larger region than desired, thereby reducing the effective dosage to less than what is desired. Other undesirable effects could also occur.

In some circumstances, it is desirable to implant ions at a temperature below ambient temperature, such as to allow for desirable amorphization of the surface of the workpiece 118 (e.g., a semiconductor workpiece such as a silicon wafer) enabling ultra shallow junction formation in advanced CMOS integrated circuit device manufacturing. Accordingly, a cooling system 124 is provided, wherein the cooling system is configured to cool or chill the electrostatic chuck 120, and thus, the workpiece 118 residing thereon, to temperatures that are considerably lower than an ambient or atmospheric temperature of the surroundings or second environment 126 (e.g., also called an “external environment” or “atmospheric environment”).

In accordance with another aspect of the present disclosure, a load lock chamber 128 is further provided in selective fluid communication with the first environment 122 of the end station 106 and the second environment 126, wherein the load lock chamber is configured to permit a transfer of the workpiece 118 into and out of the vacuum system 100 (e.g., the ion implantation system 101) without compromising the quality of vacuum, i.e., the first environment, within the vacuum system.

The inventors appreciate that ion implantations that are performed at chilled temperatures (e.g., any temperature below the dew point temperature of the second environment 126), for example, can cause condensation to form on the workpiece 118 if the workpiece transferred from the first environment 122 within the ion implantation system 101 to the external environment when the workpiece is cooler than the dew point temperature of the second environment. If the temperature of the workpiece 118 is below the freezing point of water, for example, the workpiece can develop frost (e.g., deposited frozen water vapor) upon being exposed to ambient water (e.g., humidity) in the ambient air of the second environment 126.

Accordingly, the load lock chamber 128 is coupled to a process chamber 130 associated with the end station 106 for maintaining the first environment 122 (e.g., a dry, vacuum environment) within the vacuum system 100. A load lock chamber environment 132 within the load lock chamber 128 and the second environment 122 in the present example are referred to as an “in air environment”, such as when the workpiece 118 travels between a workpiece transport container 134 (e.g., a FOUP) and the load lock chamber, wherein the in-air environment is designed for particular gas/air flows that minimize turbulence and particles.

The workpiece transport container 134, for example, is generally in an atmosphere (e.g., the second environment 126) that can have a relatively high dew point. For example, most in-air workpiece handling exposes the workpiece 118 to the atmospheric environment. The workpiece 118 is removed from the workpiece transport container 134 via a transfer mechanism 135A and travels through the second environment 126, and is subsequently placed into the load lock chamber 128 via a first door 136 of the load lock chamber. The first door 136 of the load lock chamber 128 selectively isolates the load lock chamber environment 132 from the second environment 126. A second door 138 of the load lock chamber 128 further selectively isolates the load lock chamber environment 132 from the first environment 122 within the end station 130 of the vacuum system 100. Thus, when the first door 136 is in an opened position exposing the load lock chamber environment 132 to the second environment 126, the second door 138 is in a closed position, isolating the load lock chamber environment the first environment 122.

Once the workpiece 118 is positioned within the load lock chamber 128, the first door 136 is closed and the load lock chamber environment 132 is pumped to the pressure associated with the first environment 122 within the process chamber 130, such as a vacuum provided by a vacuum source 140. After the pressure in load lock chamber environment 132 and the first environment 122 is generally equalized, the second door 138 is opened, and the workpiece is transferred into the process chamber 130 for subsequent processing (e.g., ion implantation) via another transfer mechanism 135B.

Once processing is complete, the workpiece 118 is transferred back into the load lock chamber 128. The load lock chamber 128 is subsequently vented via a gas source 142 (also called a vent source) such that the pressure in the load lock chamber environment 132 is generally increased to atmospheric pressure, or the pressure of the second environment 126. The gas source 142, for example, is in selective fluid communication with the load lock chamber environment 132 within the load lock chamber 128. In one example, the gas source 142 provides dry nitrogen to vent the load lock chamber environment 132 to atmospheric pressure, wherein once at atmospheric pressure, the first door 136 of the load lock chamber 130 is opened fluidly communicate with the second environment 126. The gas source 142, in another example, comprises one or more of hydrogen, helium argon, or another inert gas. For example, the gas source 142 is configured to provide a mixture of gases, such as “forming gas” comprising 4% hydrogen and 96% nitrogen, wherein a benefit of a higher heat capacity of hydrogen is provided, along with the low expense of nitrogen and safety of not having an explosive concentration of gases. Further, in accordance with another example, a gas source heater 143 is provided to heat the gas or mixture of gases from the gas source 142 prior to entering the load lock chamber 130 for heating the workpiece 118, as will be discuss infra. The gas source heater 143, for example, is configured to heat the gas from the gas source 142 to a predetermined temperature, such as 100 C to 150 C, wherein adequate heating of the workpiece 118 is availed without detriment (e.g., a temperature that will not cause photoresist degradation on the workpiece, etc.).

Hot gas from the gas source 142 will warm faster than a cooler gas. The transient temperature of the wafer can be described by the equation:

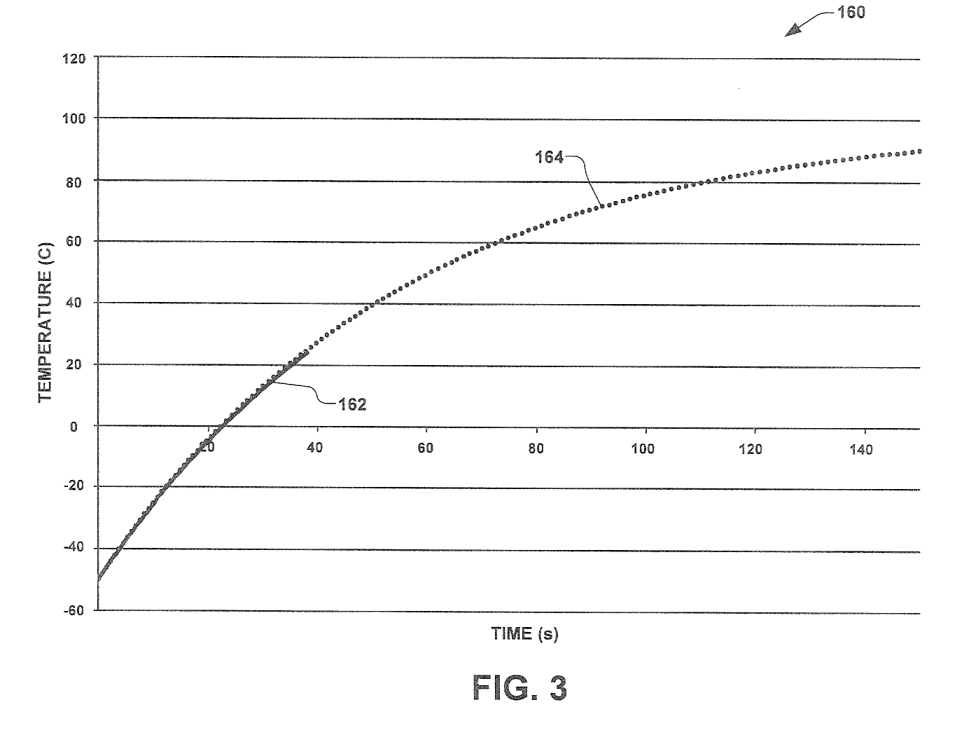

T(t)=T_{∞}+(T₀−T_{∞})exp(−(t−t₀)/τ) (1)

where: T(t) is the temperature of the workpiece 118 as a function of time, T_{∞} is the desired temperature, T₀ is the initial temperature, t is time, t₀ is the start time, and r is a time constant associated with the heating of the workpiece, which depends on the geometry, material properties and gas flow rates. FIG. 3 illustrates a plot 160 of temperature versus time for a workpiece warming with the gas from the gas source 142 of FIG. 1 being heated to 100° C. and an initial wafer temperature of −40° C., wherein a power balance 162 and exponential curve fit 164 is shown.

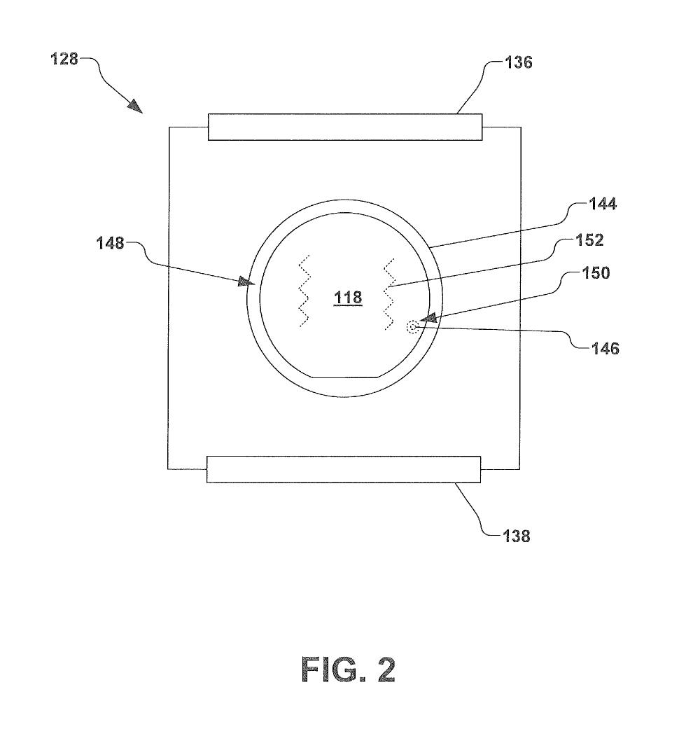

In accordance with one example of the present disclosure, the first door 136 of the load lock chamber 130 of FIG. 1 is opened to atmosphere only once the temperature of the workpiece 118 is above the dew point of the second environment 126. For example, it is not necessary that the temperature of the workpiece 118 reach the ambient temperature (e.g., 18 C-20 C) of the second environment 126, but the temperature of the workpiece is raised above the local dew point in the second environment (e.g., ambient air). In accordance with one example, as illustrated in greater detail in FIG. 2, the load lock chamber 130 comprises a platen 144 configured to accept the workpiece 118. For example, the workpiece 118 rests on the platen 144. A workpiece temperature monitoring device 146 is further provided within the load lock chamber 130, wherein the workpiece temperature monitoring device is configured to measure a temperature of the workpiece 118. The workpiece temperature monitoring device 146, for example, is integrated into the platen 144, such as a thermocouple associated with a surface 148 of the platen.

The workpiece temperature monitoring device 146, for example, can be positioned anywhere on the platen 144 such that an accurate temperature of the workpiece 118 can be determined. For example, the workpiece temperature monitoring device 146 comprises a contact thermocouple that is pressed to the backside of the workpiece 118. Another example comprises a thermocouple contacting an edge of the workpiece. Other alternative workpiece temperature monitoring devices 146 comprise infrared (IR) measurement devices, a 2-color pyrometer, other resistive thermal devices or thermistors, or other suitable temperature measurement devices.

A shrouded region 150, for example, is further provided such that the workpiece temperature monitoring device 146 is generally shielded from heated gas from the gas source 142 when the workpiece 118 resides on the platen 144. Further, according to another example, a heater 152 is associated with the platen 144, wherein the heater is configured to heat the workpiece 118.

Thus, according to one exemplary aspect, an external monitoring device 154 is provided, as illustrated in FIG. 1, wherein the external monitoring device is configured to monitor and/or measure the temperature in the second environment 126 (e.g., proximate to the load lock chamber 130). The external monitoring device 154, for example, is further configured to measure a relative humidity (RH) of the second environment 126 proximate to the load lock chamber 130. The inventors appreciate that the proximity of the external monitoring device 154 to the vacuum system 100 should be as near as possible to the transfer of workpiece 118 between the load lock chamber 130 and the workpiece transport container 134, as flow paths, FOUR movement, external building climate controls, local weather, season, rain, heat, etc. can lead to variations in temperature, pressure, and humidity. The gas source 142, for example, introduces dry gas to the second environment 126 when the first door of the load lock chamber 130 is opened, and as such, the dew point could be lower than a position much further from the vacuum system 100, such as where an operator stands to operate the vacuum system.

Accordingly, after processing of the workpiece 118 within the process chamber 130 (e.g., the workpiece is cooled via the cooling system 124 and ESC 120), the workpiece is positioned on the platen 144 in load lock chamber 128. Once the second door 138 of the load lock chamber 128 is closed, the gas source 142 is configured to flow the gas (e.g., heated gas) over the workpiece 118, thus adding heat to the workpiece, while the temperature of the workpiece is measured by the workpiece temperature monitoring device 146, and the dew point (e.g., temperature and relative humidity) of the second environment 126 is determined by the external monitoring device 154. Using software logic in a controller 156, for example, a determination is can be made as to whether the temperature of the workpiece 118 within the load lock chamber 128 is at or above the dew point of the second environment 126. Once the temperature of the workpiece 118 is at or above the dew point of the second environment, the workpiece 118 is removed from the load lock chamber 128 via the first door 136. In one example, a small period of time, or small temperature range (e.g., 2-3 degrees) is added prior to opening the first door 136 of the load lock chamber in order to ensure that the entire workpiece 118 is above the dew point of the second environment 126.

Thus, the controller 156 is configured to determine a temperature of the workpiece 118 at which condensation will not form on the workpiece when the workpiece is transferred from the load lock chamber 128 to the second environment 126, wherein the determination is made based on data from the workpiece temperature monitoring device 146 and external temperature monitoring device 154. The controller 156, for example, is further configured to selectively supply the dry gas from the dry gas source 142, based on the data from the workpiece temperature monitoring device 146 and external monitoring device 154.

It should be noted that alternative methods and apparatus for heating the workpiece 118 within the load lock chamber 128 are also contemplated, such as heating with heat lamps, LEDs, microwaves, heated fluid, any method or apparatus for heating the workpiece within the load lock chamber.

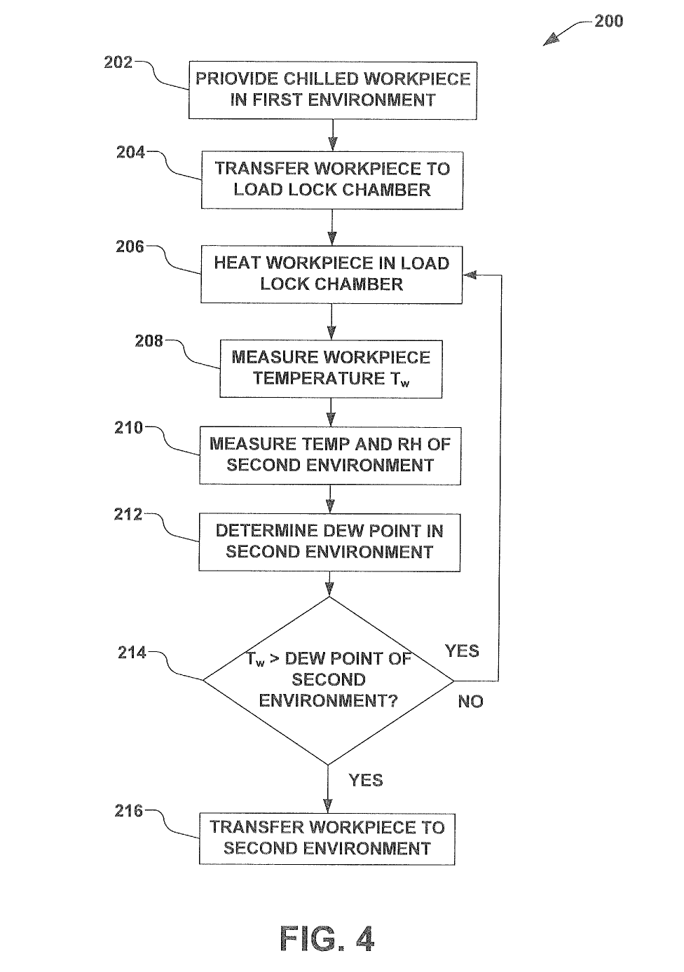

In accordance with another exemplary aspect of the invention, FIG. 4 illustrates an exemplary method 200 for preventing condensation on a workpiece is provided. It should be noted that while exemplary methods are illustrated and described herein as a series of acts or events, it will be appreciated that the present invention is not limited by the illustrated ordering of such acts or events, as some steps may occur in different orders and/or concurrently with other steps apart from that shown and described herein, in accordance with the invention. In addition, not all illustrated steps may be required to implement a methodology in accordance with the present invention. Moreover, it will be appreciated that the methods may be implemented in association with the systems illustrated and described herein as well as in association with other systems not illustrated.

The method 200 of FIG. 4 begins at act 202, wherein a workpiece is cooled in a first environment within a vacuum system, such as the vacuum system 100 of FIG. 1 described above. In act 204 of FIG. 4, the workpiece is transferred from the first environment to a load lock chamber, and the load lock chamber is consequently isolated from the first environment. In act 206, the workpiece is heated within the load lock chamber, and in act 208, a temperature of the workpiece is measured. For example, a heated gas is flowed over the workpiece. Further, in act 210, which can be concurrent with act 208, a temperature and relative humidity of a second environment is measured. In act 212, a dew point of the second environment is determined, such as by the temperature and relative humidity measured in act 210. A convenient approximation for the dew point valid over a range of temperature from 0° C. to +60° C., and a range of relative humidity from 0% to 100% is:

$${T}_{D} = \frac{237.7 [ \frac{17.271 T}{237.7 + T} + ln ( \frac{RH}{100} ) ]}{17.271 - \frac{17.271 T}{237.7 + T} + ln ( \frac{RH}{100} )} \qquad ( 2 )$$

where: T_{D} is the dew point temperature, T is the local temperature in the second environment in ° C., and RH is the relative humidity in percent.

In act 214, a determination is made as to whether the temperature of the workpiece is greater than the dew point of the second environment, and if it is, the workpiece is transferred from the load lock chamber to the second environment in act 216. As such, condensation on the workpiece is generally prevented.

It should be noted that the present invention is not limited to a chilled electrostatic chuck, and contemplates the use of active dew point measurement with other low temperature implant concepts such as, for example, a pre chiller approach as described commonly-owned U.S. Patent Application Serial Number 2008/0044938, the contents of which are incorporated by reference herein. Further, the present invention does not require that the temperature monitoring device 146 of FIG. 2 be a thermocouple embedded in the platen 144. Accordingly, a load lock chamber temperature, for example, may be monitored anywhere within the load lock chamber 128. Thus, any temperature monitoring in the load lock chamber 128, and/or any temperature monitoring of the workpiece 118 prior to opening the load lock chamber to the in-air environment (e.g., the second environment 126 or atmosphere) is contemplated as falling within the scope of the present invention.

The present disclosure thus provides for an increase in productivity of the ion implantation system 101 of FIG. 1. By actively heating the workpiece 118 with heated gas measuring the temperature of the workpiece 118 within the load lock chamber 128, and actively measuring the dew point in the mini-environment (the second environment 126), the theoretical maximum efficiency of workpiece throughput can be achieved. Thus, by measuring the wafer temperature and the dew point (RH) in the in second environment 126, an earliest time to remove the wafer is deduced.

Accordingly, the present invention provides an apparatus, system, and method for controlling condensation on a workpiece. Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A system for preventing condensation on a workpiece, the system comprising:
an source configured to form an ion beam;
a beamline assembly configured to mass analyze the ion beam;
an end station having a first environment associated therewith, wherein the end station comprises a chilled electrostatic chuck configured to clamp and cool the workpiece during an implantation of ions from the ion beam;
a load lock chamber operably coupled to the end station and in selective fluid communication with the first environment and a second environment, wherein the load lock chamber comprises a platen configured to accept the workpiece, wherein the platen comprises a workpiece temperature monitoring device configured to measure a temperature of the workpiece, and wherein the second environment has a higher dew point than the first environment;
an external monitoring device, wherein the external monitoring device is configured to measure a temperature and relative humidity in the second environment; and
a controller configured to determine a temperature of the workpiece at which condensation will not form on the workpiece when the workpiece is transferred from the load lock chamber to the second environment, wherein the determination is made based on data from the workpiece temperature monitoring device and external temperature monitoring device.

2. The system of claim 1, further comprising one or more transfer mechanisms configured to transfer the workpiece from the end station to the load lock chamber and from the load lock chamber to the second environment.

3. The system of claim 1, wherein the second environment comprises an in-air environment between the load lock chamber and a FOUR.

4. The system of claim 1, wherein the a workpiece temperature monitoring device comprises a thermocouple associated with a surface of the platen.

5. The system of claim 4, wherein the platen comprises a shrouded area associated with the thermocouple, wherein the thermocouple is generally shielded from process gases when the workpiece resides on the platen.

6. The system of claim 1, further comprising a dry gas source in fluid communication with the load lock chamber, wherein the gas source is configured to provide heated, dry gas to the load lock chamber.

7. The system of claim 6, wherein the dry gas source comprises one or more of hydrogen, helium, argon, nitrogen, or other gas.

8. The system of claim 7, wherein the dry gas source comprises forming gas comprised of 4% hydrogen and 96% nitrogen.

9. The system of claim 6, wherein the controller is further configured to selectively supply the dry gas from the dry gas source, based on the data from the workpiece temperature monitoring device and external dew point temperature monitoring device.

10. The system of claim 1, further comprising a dry gas source in fluid communication with the load lock chamber, wherein the load lock chamber further contains a mechanism to heat the workpiece after a low temperature ion implantation.

11. A condensation abatement apparatus for an ion implantation system, the apparatus comprising:
a load lock chamber in selective fluid communication with a first environment and a second environment, wherein the load lock chamber is configured to receive a chilled workpiece from the first environment and to transfer the workpiece to the second environment, and wherein the load lock chamber comprises a workpiece temperature monitoring device configured to measure a temperature of the workpiece when the workpiece resides within the load lock chamber;
a external monitoring device associate with the second environment, wherein the external monitoring device is configured to measure a temperature and relative humidity in the second environment; and wherein the second environment has a higher dew point than the first environment;
a controller configured to determine a temperature of the workpiece at which condensation will not form on the workpiece when the workpiece is transferred from the load lock chamber to the second environment, wherein the determination is made based on data from the workpiece temperature monitoring device and external temperature monitoring device.

12. The apparatus of claim 11, wherein the load lock chamber comprises a platen on which the workpiece resides, and wherein the workpiece temperature monitoring device comprises a thermocouple associated with a bottom surface of the workpiece when the workpiece resides on the platen.

13. The apparatus of claim 12, wherein the platen comprises a shrouded region associated with the thermocouple, wherein the thermocouple is generally shielded from process gases when the workpiece resides on the platen.

14. The apparatus of claim 11, further comprising a dry gas source in fluid communication with the load lock chamber, wherein the gas source is configured to provided heated, dry gas to the load lock chamber.

15. The apparatus of claim 14, wherein the dry gas source comprises one or more of hydrogen, helium, argon, nitrogen, or other inert gas.

16. The apparatus of claim 15, wherein the dry gas source comprises forming gas comprised of 4% hydrogen and 96% nitrogen.

17. The apparatus of claim 14, wherein the controller is further configured to selectively supply the dry gas from the dry gas source, based on the data from the workpiece temperature monitoring device and external monitoring device.

18. The apparatus of claim 11, further comprising a dry gas source in fluid communication with the load lock chamber, wherein the load lock chamber further contains a mechanism to heat the workpiece after a low temperature ion implantation.

19. A method for preventing condensation on a workpiece, the method comprising:
transferring a workpiece from a first environment to a load lock chamber;
warming the workpiece in the load lock chamber;
measuring a temperature of the workpiece in the load lock chamber;
measuring a temperature and relative humidity of a second environment;
calculating a dew point of the second environment; and
transferring the workpiece from the load lock chamber to the second environment after the temperature of the workpiece is greater than a dew point of the second environment.

20. The method of claim 19, wherein the measuring the temperature of the workpiece in the load lock chamber comprises measuring temperature at one or more locations on a backside of the workpiece.

21. The method of claim 19, wherein transferring the workpiece from the load lock chamber to the second environment occurs after the temperature of the workpiece is greater than a dew point of the second environment by a predetermined amount.

22. The method of claim 19, wherein transferring the workpiece from the load lock chamber to the second environment occurs after a predetermined period of time once the temperature of the workpiece is greater than a dew point of the second environment by a predetermined amount.
